(19) United States
(12) Patent Application Publication
(10) Pub. No.: US 2013/0306217 A1
(43) Pub. Date: Nov. 21, 2013

(54) INSPECTION METHOD FOR WHEEL CLADDING

(71) Applicant: Frank D. Risko, Clarkston, MI (US)

(72) Inventor: Frank D. Risko, Clarkston, MI (US)

(73) Assignee: GM GLOBAL TECHNOLOGY OPERATIONS LLC, DETROIT, MI (US)

(21) Appl. No.: 13/475,004

(22) Filed: May 18, 2012

(51) Int. Cl. B32B 41/00

(52) U.S. Cl. 156/64

(57) ABSTRACT

A method for inspecting a wheel assembly having a molded plastic cladding adhered to a metal wheel includes selecting an adhesive that will generate heat upon curing. The adhesive is placed between the cladding and the wheel and exhibits an exothermic heat generating reaction during curing. The cladding is inspected with a thermal imaging device to measure the exothermic heat generating reaction of the adhesive. The data collected by the thermal imaging device is analyzed to determine the quality of the adhesion between the cladding and the wheel, the wheel is accepted or rejected based upon the analysis of the collected data.

### FIELD OF THE INVENTION

The present invention relates to an improved method for inspecting the adhesive attachment of plastic wheel claddings to metal vehicle wheels.

### BACKGROUND OF THE INVENTION

It is common in the automotive industry to manufacture spoked wheels of cast aluminum and to then improve the aesthetics of the wheel by adhesively bonding a cladding of injection molded plastic onto the wheel.

A high quality adhesive bond is required in order to prevent separation of the cladding from the wheel during operation of the motor vehicle.

The quality of the adhesive bond is tested by the wheel manufacturer to prevent quality problems such as voids in the placement of the adhesive, dirt or oil on the parts being adhesively joined, or perhaps a faulty batch of adhesive that does not cure properly. Heretofore for it has been necessary to test the quality of adhesive bonds by destructive testing of a small sample of the manufactured wheels.

It would be desirable to provide a non-destructive testing process by which the quality of the adhesive bond could be continuously monitored in 100% of the manufactured wheels.

### SUMMARY OF THE INVENTION

A method for inspecting a wheel assembly having a molded plastic cladding adhered to a metal wheel includes selecting an adhesive that will generate heat upon curing. The adhesive is placed between the cladding and the wheel and exhibits an exothermic heat generating reaction during curing. The cladding is inspected with a thermal imaging device to measure the exothermic heat generating reaction of the adhesive. The data collected by the thermal imaging device is analyzed to determine the quality of the adhesion between the cladding and the wheel, and the wheel is accepted or rejected based upon the analysis of the collected data.

Further areas of applicability of the present invention will become apparent from the detailed description provided hereinafter. It should be understood that the detailed description and specific examples, while indicating exemplary embodiments of the invention, are intended for purposes of illustration only and do not limit the scope of the invention.

### BRIEF DESCRIPTION OF THE DRAWINGS

The present invention will become more fully understood from the detailed description and the accompanying drawings, wherein:

FIG. 1 is a perspective view showing a cast vehicle wheel and a plastic cladding that is to be adhesively attached to the wheel.

FIG. 2 is a side elevation view through the wheel after the cladding has been adhesively secured to the wheel.

FIG. 3 is a process flow chart showing the method of this invention.

### DETAILED DESCRIPTION OF THE EXEMPLARY EMBODIMENTS

The following description of certain exemplary embodiments is merely exemplary in nature and is not intended to limit the invention, its application, or uses.

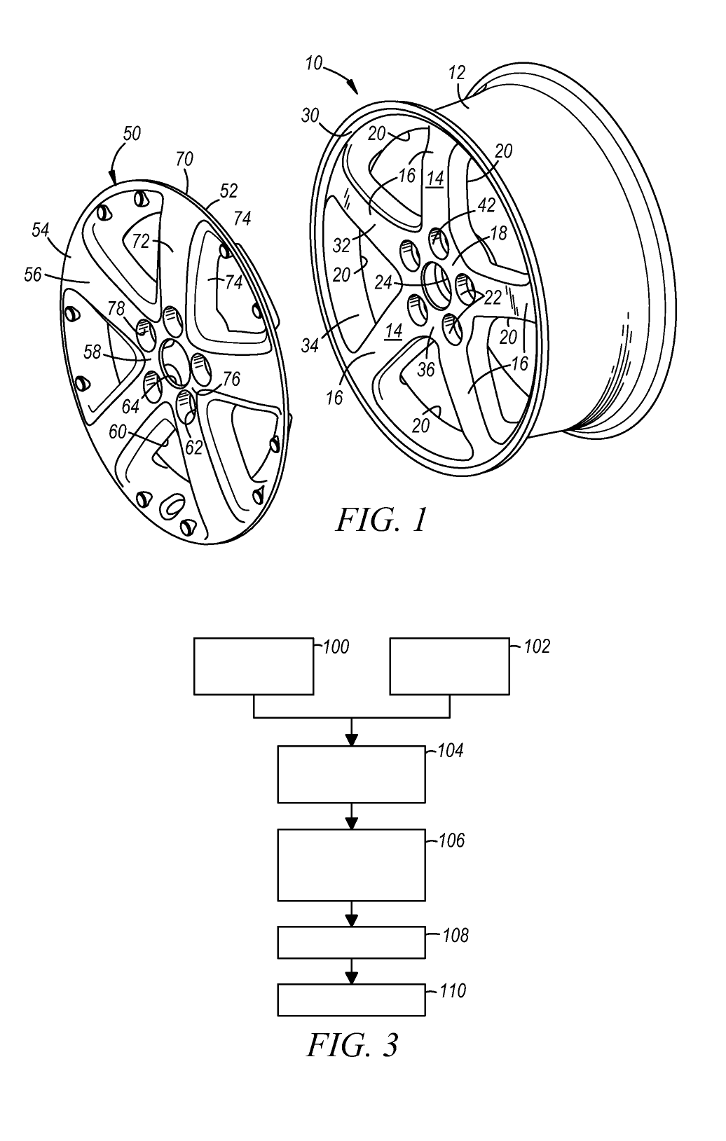

Referring to FIG. 1, a vehicle wheel 10 is of cast aluminum construction, for example aluminum alloy A356. The wheel 10 is cast in one piece and includes generally a wheel rim portion 12 that will mount a tire, and a wheel disc portion 14 that will bolt to a vehicle axle. Alternatively, the wheel 10 can be assembled by welding together a sheet metal components. Or the wheel can be a forging. The wheel can be of a metal other than aluminum.

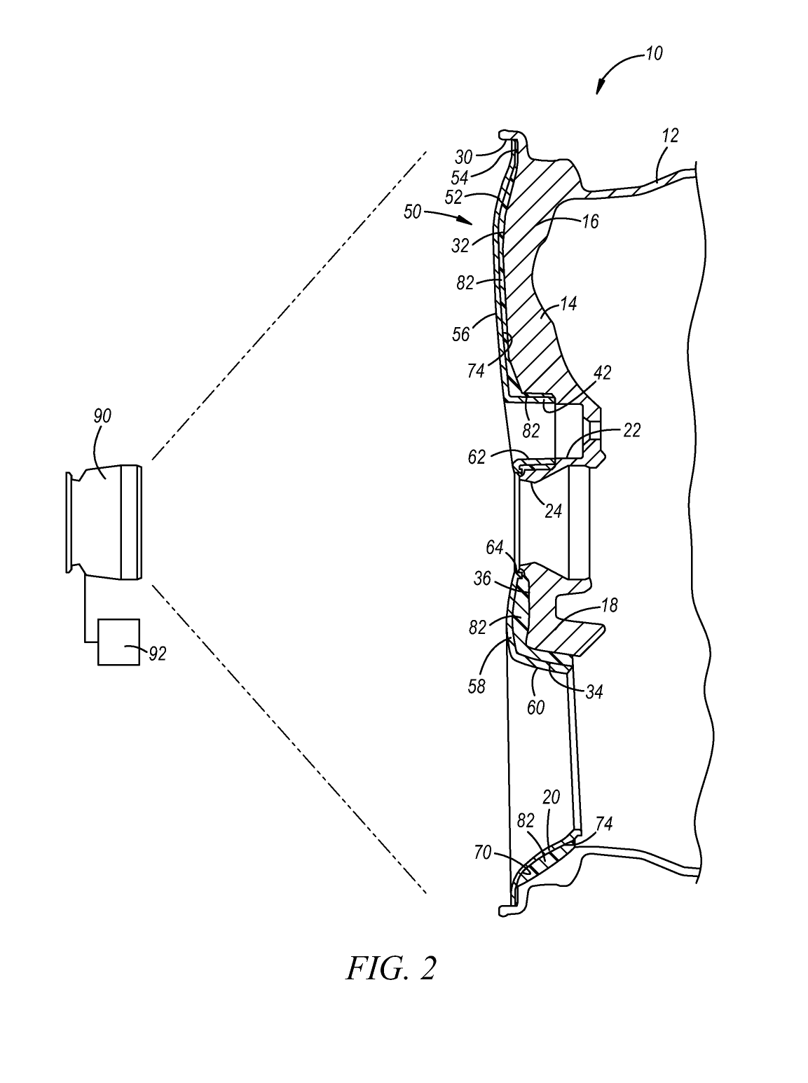

As seen in FIGS. 1 and 2, the wheel disc portion 14 includes a plurality of wheel spokes 16 that emanate from a wheel central hub 18 and connect with the wheel rim portion 12. The wheel spokes 16 are defined by wheel disc openings 20. The wheel central hub 18 has a plurality of wheel lug bolt openings 22 and a wheel central pilot aperture 24.

Thus, as seen in FIGS. 1 and 2, the outward facing walls of the vehicle wheel 10 include a wheel rim wall 30 at the outer peripheral edge of the wheel 10, a wheel outer spoke wall 32 of each of the wheel spokes 16, inwardly directed wheel flange walls 34 of the wheel spokes 16 at the wheel disc openings 20, a wheel outer hub wall 36 of the wheel central hub 18, and an inwardly directed wheel bolt hole wall 42 that defines the wheel lug bolt openings 22.

Referring again to FIGS. 1 and 2, it is seen that a cladding 50 is provided for attachment onto the wheel 10 in order to aesthetically dress the wheel. The wheel cladding 50 is preferably of injected molded plastic substrate 52, such as a blend of polycarbonate and ABS. The wheel cladding 50 also has a decorative coating provided on the plastic substrate 52. The decorative coating is most often an electrochemically plated or painted treatment that provides a chrome-plated appearance or a color that complements or contrasts with the color of the motor vehicle.

The wheel cladding 50 has wall portions thereof that closely overlie the wall portions of the wheel 10 to be adhesively secured with the corresponding wall portion of the wheel 10. In particular, the wheel cladding 50 has an outer rim portion 54, a plurality of spokes 56, a central hub 58, disc openings 60, and lug bolt openings 62, and a central aperture 64. Thus, the wheel cladding 50 has a rim wall 70 that overlies the rim wall 30 of the wheel 10, spoke walls 72 that overly the outer spoke wall 32 of the wheel 10, inwardly directed flange walls 74 that overlie the inwardly directed flange walls 34 of the wheel 10, and an outer hub wall 76 that overlies the outer hub wall 36 of the wheel 10, and inwardly directed bolt hole walls 78 that overlie the wheel lug bolt openings 22.

In FIG. 1, the wheel 10 and cladding 50 are shown separately, prior to the cladding being installed upon the wheel 10. FIG. 2 shows the cladding 50 adhesively secured to the wheel 10, thereby creating a wheel assembly.

As seen in FIG. 2, a layer of adhesive 82 has been placed between the walls of the cladding 50 and the wheel 10 and cured to securely adhere the cladding 50 in place. The adhesive may be placed between the cladding 50 and wheels 10 by various methods. For example, the cladding 50 can be retained by a fixture at a precise spaced location relative to the wheel 10 to define an adhesive receiving space therebetween. Then, the adhesive, in liquid form, can be injected into the adhesive receiving space. Alternatively, the adhesive 82 can be applied as a bead to either the outer face of the wheel 10 or to the inner face of the cladding 50. Then the cladding 50 and wheel 10 are married together with the bead of adhesive 82 being squeezed therebetween to create the adhesive attachment. The cladding 50 can be fixtured relative to the wheel 10 by exterior fixture devices that engage both the cladding 50 and the wheel 10. Or the fixturing of the wheel 10 and cladding 50 relative one another can be achieved by a frictional engagement between the wheel 10 and cladding 50 that is provided by inter-engaging walls and spacers formed integrally on either the wheel 10 or the cladding 50.

Although many adhesives are available in the marketplace, my invention is practiced by selecting an adhesive that is exothermic upon curing, that is, heat is generated by the chemical reaction occurring during the curing of the adhesive 82. An example of such an adhesive is the two-part isocyonate/polyol urethane foam product manufactured under the Trademark Betafoam 87100-87124 by the Dow Chemical Company.

Referring again to FIG. 2, is seen that a thermal imaging device 90 is poised adjacent the assembled cladding 50 and wheel 10 to inspect the quality of the adhesive bond between the cladding 50 and wheel 10. The thermal imaging device is connected to an analyzer system 92. The thermal imaging device 90, observes the cladding 50 in order to measure the temperature of the surface thereof. In general, the existence of heat indicates that the adhesive 82 is in place and is generating heat due to the curing of the adhesive 82. On the other hand, the absence of heat indicates that a there may be a void in the placement of the adhesive 82, or there is a fault in the curing action of the adhesive such that the heat indicative of proper curing is not being generated.

FIG. 2 shows the example of a single thermal imaging device 90 that can observe the entire cladding 50, including the outer rim portion 54, spokes 56 and the central hub 58 of the cladding 50. Alternatively, a plurality of thermal imaging devices could be employed with each observing a different part of the cladding 50.

The thermal imaging device or devices can be stationary and the wheel and cladding can be stationary. Or the thermal imaging device or devices can be independently mounted on robotic manipulators to move about the cladding 50 taking temperature readings. Or alternatively, the wheel 10 and cladding 50 can be rotated relative to a fixed arrangement of the thermal imaging device or devices.

FIG. 3, shows a process chart for conducting the inspection process. At step 100 the temperature of the wheel 10 is sensed, and at step 102 the temperature of the cladding is sensed. These temperatures are sensed prior to the adhesive attachment together of the wheel 10 and cladding 50 in order to establish background temperature conditions of the separate parts. At step 104, the adhesive 82 is placed and the wheel 10 and cladding 50 are fixtured to allow time for curing of the adhesive 82. At step 106, the adhesive curing process is monitored by the thermal imaging device 90. At step 108, the data collected by the thermal imaging devices is analyzed and a decision made to either accept or reject the assembled wheel. At step 110 the clad wheels are either accepted or rejected. If rejected, the wheel assembly can be ejected from the manufacturing line or the rejected wheel can be labeled as defective and removed later.

The analysis of the data can include looking at only the temperatures that are generated, or looking at the presence of voids in the heat generation indicative of a void in the adhesive. More preferably, the analysis includes both the temperatures and the local temperature gradients in order to make a highly accurate quantitative decision as to whether the adhesive bonding has achieved a certain overall threshold indicative of acceptable product quality.

In some case, the emissivity characteristics of the coating provided on the cladding 50 may adversely affect the ability of the thermal imaging device 90 to read the temperatures of the cladding 50. For example, the use of chrome plating may provide a low emissivity condition that renders it difficult to distinguish the temperature differences within differing regions of the adhesive 82. In order to improve the emissivity, the chrome plating can be temporarily covered with a black colored coating, such a black powder soot, which can be applied to the surface and then easily removed by a wash of water or compressed air. Alternatively, a black tape, such as a film with a tacky coating, is applied to the surface and removed after the inspection process.

What is claimed is:

1. A method for inspecting a wheel assembly having a molded plastic cladding adhered to a metal wheel comprising:
selecting an adhesive that will generate heat upon curing;
placing the adhesive between the cladding and the wheel, said adhesive exhibiting an exothermic heat generating reaction during curing thereof;
inspecting the cladding with a thermal imaging device to measure the exothermic heat generating reaction of the adhesive;
analyzing the data collected by the thermal imaging device to determine the quality of the adhesion between the cladding and the wheel;
and accepting or rejecting the wheel assembly based upon the analysis of the collected data.

2. The method of claim 1 further comprising placing the adhesive between the cladding and the wheel by fixturing the cladding and the wheel relative one another to create a space there between, and then injecting the adhesive into the space.

3. The method of claim 1 further comprising placing the adhesive between the cladding and the wheel by dispensing the adhesive on to either the cladding or the wheel and then marrying the cladding and the wheel together to squeeze the adhesive between the cladding and the wheel.

4. The method of claim 1 further comprising the analyzing of the data collected by the thermal imaging device looking at only the temperatures generated.

5. The method of claim 1 further comprising the analyzing of the data collected by the thermal imaging device looking only at the presence of voids in the heat generation indicative of a void in the adhesive placement.

6. The method of claim 1 further comprising the analyzing of the data collected by the thermal imaging device looking at both the temperatures generated and the presence of voids in the heat generation indicative of a void in the adhesive placement.

7. The method of claim 1 further comprising temporarily coating the cladding with a black coating to improve the emissivity of the cladding to improve the ability of the thermal imaging device to sense the temperature the cladding.

8. The method of claim 7 further comprising the temporary coating being a black soot.

9. The method of claim 8 further comprising removing the temporary coating of black soot by washing the wheel assembly with water or compressed air.

10. The method of claim 7 further comprising the temporary coating being a black tape applied to the cladding and then later stripped from the cladding.

11. Method of claim 1 further comprising the thermal imaging device including one or more sensors mounted either stationary or movably relative the wheel assembly.

12. A method for inspecting a wheel assembly having a molded plastic cladding adhered to a metal wheel comprising:
selecting an adhesive that will generate heat upon curing;
fixturing the cladding and the wheel relative one another to create a space there between,
injecting the adhesive between the cladding and the wheel, said adhesive exhibiting an exothermic heat generating reaction during curing thereof;
inspecting the cladding with a thermal imaging device to measure the exothermic heat generating reaction of the adhesive;
analyzing the data collected by the thermal imaging device to determine the quality of the adhesion between the cladding and the wheel;
and accepting or rejecting the wheel based upon the analysis of the collected data.

13. The method of claim 12 further comprising the analyzing of the data collected by the thermal imaging device looking at one or both of the temperatures that are generated and the presence of voids in the heat generation indicative of a void in the adhesive placement.

14. The method of claim 12 further comprising temporarily coating the cladding with a black coating to improve the emissivity of the cladding and ability of the thermal imaging device to sense the temperature of the cladding.

15. The method of claim 13 further comprising the temporary black coating being either a layer of soot or a black adhesive tape.

16. A method for inspecting a wheel assembly having a molded plastic cladding adhered to a metal wheel comprising:
selecting an adhesive that will generate heat upon curing;
dispensing the adhesive onto either the cladding or the wheel;
marrying the cladding to the wheel to squeeze the adhesive there between;
inspecting the cladding with a thermal imaging device to measure the exothermic heat generating reaction of the adhesive;
analyzing the data collected by the thermal imaging device to determine the quality of the adhesion between the cladding and the wheel;
and accepting or rejecting the wheel based upon the analysis of the collected data.

17. The method of claim 16 further comprising the analyzing of the data collected by the thermal imaging device including looking at one or both of the temperatures that are generated and the presence of voids in the heat generation indicative of a void in the adhesive placement.

18. The method of claim 16 further comprising temporarily coating the cladding with a black coating to improve the emissivity of the cladding and the ability of the thermal imaging device to sense the temperature the cladding.

19. The method of claim 18 further comprising the temporary black coating being either a layer of soot or a black adhesive tape.
